(19) United States
(12) Patent Application Publication
(10) Pub. No.: US 2020/0231170 A1
(43) Pub. Date: Jul. 23, 2020

(54) METHOD AND CONTROL DEVICE FOR MONITORING THE BLIND SPOT OF A TWO-WHEELED VEHICLE

(71) Applicant: Robert Bosch GmbH, Stuttgart (DE)

(72) Inventors: Mathieu Grelaud, Ludwigsburg (DE); Michael Schoenherr, Renningen-Malmsheim (DE)

(21) Appl. No.: 16/652,852

(22) PCT Filed: Sep. 12, 2018
(86) PCT No.: PCT/EP2018/074658

§ 371 Date: Apr. 1, 2020

(30) Foreign Application Priority Data
Nov. 9, 2017 (DE) 10 2017 219 902.4

(51) Int. Cl. B60W 50/14; B60W 30/08; B60W 30/18

(52) U.S. Cl. CPC B60W 50/14; B60W 30/08; B60W 2300/36; B60W 2554/4049; B60W 30/18163

(57) ABSTRACT

A method for monitoring a blind spot of a two-wheeled vehicle includes a step of using traffic lane information representing a position of the two-wheeled vehicle in its lane and/or a position of at least one adjacent lane to define at least one warning region that at least partially includes a blind spot and a step of providing a blind spot warning if object information that represents a position of another vehicle displays the other vehicle within the warning region.

### CROSS-REFERENCE TO RELATED APPLICATIONS

The present application is the national stage of International Pat. App. No. PCT/EP2018/074658 filed Sep. 12, 2018, and claims priority under 35 U.S.C. § 119 to DE 10 2017 219 902.4, filed in the Federal Republic of Germany on Nov. 9, 2017, the content of each of which are incorporated herein by reference in their entireties.

### FIELD OF THE INVENTION

The present invention relates to a method for monitoring the blind spot of a two-wheeled vehicle and to a control device for monitoring the blind spot of a two-wheeled vehicle.

### BACKGROUND

When a rear view mirror of a vehicle is properly adjusted, a driver of the vehicle can see a limited area behind the vehicle in the rear view mirror. The outside, or side, mirrors of the vehicle also permit at least some of the area behind the vehicle to be seen by the driver. Objects within the blind spots of the vehicle are those which are laterally offset relative to the vehicle, and/or next to the vehicle, but do not appear in the outside mirrors or are not perceptible through peripheral vision. If another vehicle driving offset relative to the vehicle is located within the blind spot and the driver misses it, a serious accident can occur if the driver makes a turn or a lane change.

A vehicle driving in the blind spot can be detected using ultrasonic sensors, for example, and a warning can be issued for the driver.

### SUMMARY

With this background, the approach presented here provides a method for monitoring a blind spot of a two-wheeled vehicle, a control device for monitoring a blind spot of a two-wheeled vehicle, and a corresponding computer program product.

Example embodiments of the present invention can advantageously enable a certain recognition of a danger of another vehicle driving in an adjacent lane offset relative to a two-wheeled vehicle, independent of a position of the two-wheeled vehicle in its own lane, and to warn the driver of the two-wheeled vehicle. On the other hand, no warning is given about another vehicle in the second lane over since there is no blind spot conflict situation in effect as long as there is an unoccupied lane between the two-wheeled vehicle and the other vehicle.

According to an example embodiment of the present invention, a method for monitoring a blind spot of a two-wheeled vehicle includes a step of defining at least one warning region at least partially comprising a blind spot using traffic lane information representing a position of the two-wheeled vehicle in its traffic lane and/or a position of at least one adjacent traffic lane, and a step of providing a blind spot warning if object information representing a position of another vehicle displays the other vehicle inside the warning region.

Ideas with regard to example embodiments of the present invention can be considered to be based on the concepts and findings described below, among other things.

A two-wheeled vehicle can be understood to mean a motorized two-wheeled vehicle, such as a motorcycle or a motor scooter for example. The approach provided here can also be applied to a multi-track vehicle. A blind spot exists between a limit of an area which a rear-view mirror or side mirror can visibly capture and a limit of an area that the eyes can visibly capture when looking forward. In a two-wheeled vehicle having a right side mirror and a left side mirror, there is a blind spot of the right next to the two-wheeled vehicle and a blind spot of the left next to the two-wheeled vehicle. In a two-wheeled vehicle having a central rear-view mirror, there is a blind spot of the right and the left side, respectively.

A position in a traffic lane represents a relationship between a right distance to a right edge of the lane and a left distance to a left edge of the lane, for example. The edges can be characterized by road markings, for example. A position of an adjacent lane can be a lateral distance of the lane from the two-wheeled vehicle. In particular, the position of a right lane can be represented by a lateral distance between the two-wheeled vehicle and a right roadway boundary or right roadway marking. The position of a left lane can be represented by a lateral distance between the two-wheeled vehicle and a left roadway boundary or left roadway marking. Lane information can represent the position in the lane as a position value and/or the position of the adjacent lanes as position values.

A warning region is a virtual subarea of a detection area of an object detection device of the two-wheeled vehicle. The object detection device can be an ultrasonic sensor system, a radar system, a camera system, or a lidar system, for example. The object detection device can represent a position of an object for example as a distance from the two-wheeled vehicle to the object and as a direction from the two-wheeled vehicle to the object. The position can also be represented relative to the two-wheeled vehicle as a lateral distance and an axial distance. Object information can represent position values of recognized objects.

The warning region can cover at least the lane adjacent to the vehicle's own lane. The warning region can also include a strip of the vehicle's own lane up to the adjacent lane. This makes it possible to detect relevant vehicles.

The warning region can cover a full width of the adjacent lane. The warning region can extend up to the far roadway marking. This makes it possible to detect even two-wheeled vehicles driving at the edge of the adjacent lane.

The warning region can be defined to be smaller than a detection area of an object detection device which provides the object information. This allows all objects within the warning region to be reliably detected by the object detection device.

On one side of the two-wheeled vehicle, the warning region can be defined with a pre-defined width if the lane information indicates no adjacent lane on this side. The width of the warning region can be set to a standard value. If a roadway boundary is detected, such as a guardrail, the warning region can be defined as being between the two-wheeled vehicle and the guardrail.

A warning region can be defined on each side of the two-wheeled vehicle. Both warning regions can be defined using the lane information. The widths of the warning regions can be different. Each warning region can be adjusted individually.

The method can be implemented in software or hardware, for example, or in a control device as a mixed form of software and hardware, for example.

An example embodiment is directed to a control device designed to carry out, control, or implement, in corresponding devices, the steps of the method described herein.

The control device can be an electrical device having at least one processor for processing signals or data, at least one memory unit for storing signals or data, and at least one interface and/or one communication interface for reading in or reading out data embedded in a communication protocol. For example, the processor can be a signal processor, a system ASIC, or a microcontroller for processing sensor signals and for issuing data signals as a function of the sensor signals. The memory unit can be a flash memory, an EPROM, or a magnetic memory unit, for example. The interface can be designed as a sensor interface for reading in the sensor signals from a sensor and/or as an actuator interface for issuing the data signals and/or control signals to an actuator. The communication interface can be designed to read in or read out the data wirelessly and/or by wire. The interfaces can also be software modules which exist on a microcontroller in addition to other software modules, for example.

An example embodiment of the present invention is directed to a computer program product or computer program with program code that can be stored on a machine-readable carrier or storage medium such as a semiconductor memory, a disk memory, or an optical memory and that is used to carry out, implement, and/or control the steps of the method as recited in one of the embodiments described herein, in particular when the program product or program is run on a computer or a device.

It is noted that some of the possible features and advantages of the present invention are described here as a method and as a control device, referring to different example embodiments. A person skilled in the art will see that the features can be combined, adapted, or exchanged in a suitable manner in order to arrive at further example embodiments of the present invention.

While example embodiments of the present invention are described below with reference to the attached drawings, neither the drawings nor the description should be interpreted as limiting the invention. Additionally, the figures, in which identical reference signs signify the same features or features having the same effect, are only schematic and not to scale.

### BRIEF DESCRIPTION OF THE DRAWINGS

FIG. 1 shows a representation of a two-wheeled vehicle comprising a blind spot monitoring system according to an example embodiment of the present invention.

FIGS. 2-5 show driving situations with warning regions defined according to an example embodiment of the present invention.

### DETAILED DESCRIPTION

In the automotive sector, in vehicles such as trucks, there are blind spot monitoring systems in place based on various sensor technologies such as video, radar, or ultrasound. For motorized two-wheeled vehicles, there exists a blind spot monitoring system which is based on ultrasonic sensors. On this basis, there will also be ongoing developments in the future based on radar and/or video sensors.

ISO 17387:2008(E) describes the detection area for blind spot monitoring systems and lane change assistants for multi-track vehicles. This can be similarly applied to two-wheeled vehicles. However, two-wheeled vehicles do not always drive exactly in the center of the lane. Thus, according to ISO 17387:2008(E), performance related to correct, missing, and incorrect warnings depends on the lateral position of the two-wheeled vehicle inside the lane.

When the warning region is fixed and the lateral positions inside the lane vary, good coverage of the adjacent lanes only occurs in the middle position in the lane. When driving at the edge of the lane, coverage of one of the adjacent lanes is insufficient, which can result in possible missed warnings in the case of other two-wheeled vehicles. On the other hand, the warning region can cover too large of a portion of the road, which can result in false warnings in the case of other cars.

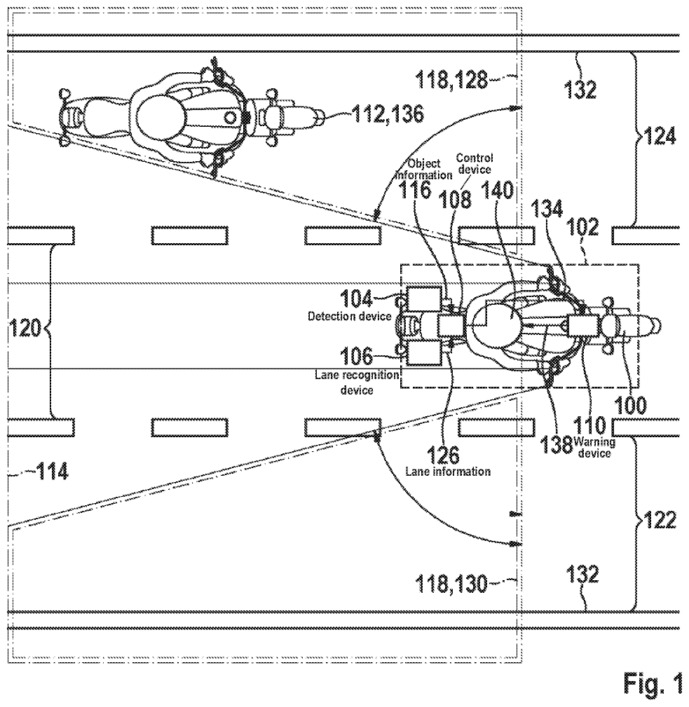

FIG. 1 shows a representation of a two-wheeled vehicle 100 comprising a blind spot monitoring system 102 according to an example embodiment of the present invention. The two-wheeled vehicle 100 is a motorcycle in this case. The blind spot monitoring system 102 comprises a surrounding environment detection device 104, a lane recognition device 106, a control device 108, and a warning device 110.

The surrounding environment detection device 104 detects objects 112 in a detection area 114 and issues object information 116 concerning recognized objects 112. The detection area 114 extends at least over an area behind the two-wheeled vehicle 100 and on both sides of the two-wheeled vehicle 100. Thus, the detection area 114 covers at least the blind spot 118 of the two-wheeled vehicle 100.

The lane detection device 106 recognizes a position of the two-wheeled vehicle 100 inside a lane 120 in which the two-wheeled vehicle 100 is driving and a position of the lane 120 and any adjacent lanes 122, 124. In this case, the two-wheeled vehicle 100 is driving in a center lane 120 of a road. To the right of the center lane 120 is a right lane 122 and to the left of the center lane is a left lane 124. The lane detection device 106 maps the position of the two-wheeled vehicle 100 and the position of lanes 120, 122, and 124 as traffic lane information 126. The surrounding environment detection device 104 and the lane detection device 106 can also be combined into one unit.

The control device 108 reads in the object information 116 and the traffic lane information 126. The control device defines warning regions 128, 130 within the detection area 114 using the traffic lane information 126. In the process, the warning regions 128, 130 are smaller than the detection area 114 and can vary. In particular, the warning regions 128, 130 are broadened or narrowed depending on the lateral position of the two-wheeled vehicle 100 in its lane 120 and depending on the position of lateral roadway markings 132 of the adjacent lanes 122, 124 relative to a longitudinal axis of the two-wheeled vehicle 100. A length of the warning regions 128, 130 relative to a perpendicular axis of the two-wheeled vehicle 100 can be velocity-dependent or can be fixed. If an adjacent lane 122, 124 is present, the respective warning region 128, 130 is limited by the respective roadway marking 132 opposite to the vehicle's own lane 120. If part of the blind spot 118 extends beyond the bordering roadway marking 132, this part is outside of the defined warning region 128, 130. In other words, a limit is established for lane 122, 124 adjacent to the vehicle's own lane 120 as a lateral delimitation of a warning region 128, 130.

The control device 108 issues a blind spot warning 134 when another vehicle 136 is driving in one of the warning regions 128, 130 obliquely behind the two-wheeled vehicle 100. Vehicles 136 can be recognized at least from a distance of five meters. The blind spot warning 134 can result when the vehicle 136 is driving at a speed difference of less than ten km/h relative to the two-wheeled vehicle 100.

The warning device 110 provides a warning signal 138 for a driver 140 of the two-wheeled vehicle 100 when the control device 108 issues the blind spot warning 134. For example, a warning symbol appears in the outside mirror in whose blind spot vehicle 136 is recognized.

In other words, a blind spot monitoring system (Blind Spot Warning, BSW) is provided for motorcycles or two-wheeled vehicles 100, in which the warning region 128, 130 is adjusted as a function of the position of the two-wheeled vehicle 100 in lane 120.

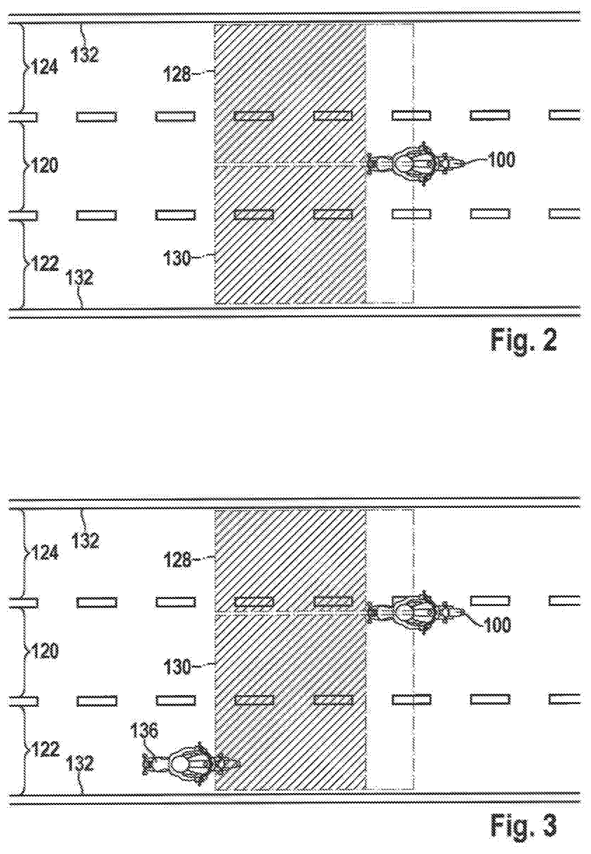

FIGS. 2-5 show driving situations with warning regions 128, 130 defined according to the approach provided here. In each driving situation, there is a two-wheeled vehicle 100 being driven that has a blind spot monitoring system as in FIG. 1. The blind spot monitoring system monitors the warning regions 128, 130 and warns the driver of the two-wheeled vehicle 100 when a vehicle 136 is detected inside one of the warning regions 128, 130.

In the approach provided here, the warning region 128, 130 of the two-wheeled vehicle 100 is not rigidly defined but adjusts in width depending on the lateral position inside lane 120.

The variable warning region 128, 130 maintains good coverage of adjacent lanes 122, 124 at different lateral positions within the vehicle's own lane 120.

The lateral position within the vehicle's own lane 120 and an adjustment of the warning regions 128, 130 as a function of the lateral position are determined cyclically.

The determination of the lateral position inside the vehicle's own lane 120 can be performed by a surrounding environment detection device such as a camera system installed in the direction of travel and having a lane recognition system, a rearward-directed camera system with lane recognition, or using a high-precision GPS position and precise map information or lane information.

If the system determines that there is no adjacent lane to the left and/or to the right, for example because of a guardrail or other roadway boundaries, the warning region 128, 130 can also be adjusted to accommodate this in order to reduce or minimize false warnings of stationary objects.

The approach provided here yields an improvement in the performance of BSW (Blind Spot Warning) systems and LCA (Lane Change Assist) functions of two-wheeled vehicles 100 due to the lower number of false warnings and fewer missed warnings. The approach provided here can also be used for improving passenger car systems.

As in FIG. 1, in FIG. 2 the two-wheeled vehicle 100 is driving approximately in the center of the center lane 120 of a three-lane road. The left warning region 128 and the right warning region 130 extend over the entire width of the adjacent lanes 122, 124 since the blind spot monitoring system adjusts the warning regions 128, 130 to the lateral position of the two-wheeled vehicle 100 within the center lane 120 and to the right border line 132 of the right lane 122 and the left border line 132 of the left lane 124.

In FIG. 3, the two-wheeled vehicle 100 is driving along a left edge of the center lane 120. The left warning region 128 is narrower here than in FIG. 2 since a left distance to the left border line 132 of the left lane 124 is less than in FIG. 2. In contrast, the right warning region 130 is wider than in FIG. 2 since a right distance to the right border line 132 of the right lane 122 is greater than in FIG. 2. Since the right warning region 130 covers the entire width of the right lane 122, the other vehicle 136 in the right blind spot is recognized and the blind spot warning is issued.

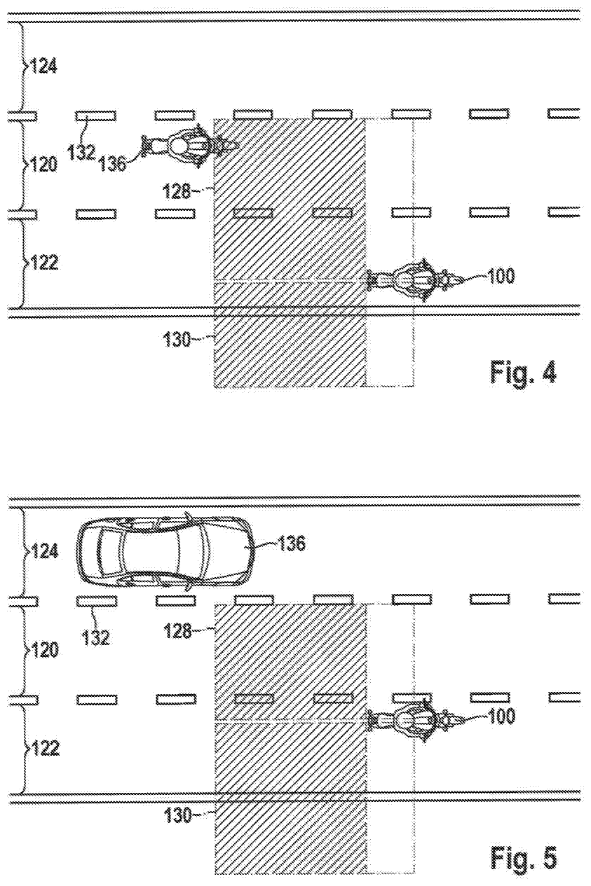

In FIG. 4, the two-wheeled vehicle 100 is driving in the right lane 122. The two-wheeled vehicle is driving along a right edge of the right lane 122. Here, the left warning region 128 is larger than in FIG. 3 since the left distance to the left border line 132 of the center lane 120 is greater here. Thus, the other vehicle 136 in the left blind spot 118 is recognized and the blind spot warning is issued. There is no lane to the right adjacent to the two-wheeled vehicle 100. The right warning region 130 extends across a shoulder of the road.

In FIG. 5, the two-wheeled vehicle 100 is driving along the left edge of the right lane 122. Here, the left warning region 128 is again less wide than in FIG. 4 since the left distance to the left border line 132 is smaller than in FIG. 4. Thus, although the other vehicle 136 in the left lane 124 is detected by the surrounding environment detection device, no blind spot warning is issued since the center lane 120 is unoccupied. The right warning region 130 extends across the right lane and the shoulder.

Finally, it is noted that terms such as “having,” “comprising,” etc., do not exclude other elements or steps and terms such as “a” do not exclude a plurality.

1-9. (canceled)

10. A method for monitoring a blind spot of a two-wheeled vehicle, the method comprising:
defining at least one warning region at least partially comprising the blind spot using traffic lane information representing a position of the two-wheeled vehicle in a traffic lane in which the two-wheeled vehicle is located and/or a position of at least one adjacent traffic lane that is adjacent to the traffic lane in which the two-wheeled vehicle is located; and
providing a blind spot warning responsive to object information that represents a position of another vehicle being inside the warning region.

11. The method of claim 10, wherein the warning region is defined to include at least a portion of the at lease one adjacent traffic lane.

12. The method of claim 10, wherein the warning region is defined to include at least an entirety of one or more of the at lease one adjacent traffic lane.

13. The method of claim 10, wherein the warning region is defined as being smaller than a detection area of an object detection device that provides the object information.

14. The method of claim 10, wherein the warning region is defined in an instance where the lane information indicates that there is no adjacent lane on a side of the two-wheeled vehicle, and the warning region is defined with a predefined width on the side at which the lane information indicates that there is no adjacent lane.

15. The method of claim 10, wherein, based on the lane information, the warning region is defined to include areas at both sides of the two-wheeled vehicle.

16. A control device comprising a processor, wherein the processor is configured to perform a method for monitoring a blind spot of a two-wheeled vehicle, the method comprising:
defining at least one warning region at least partially comprising the blind spot using traffic lane information representing a position of the two-wheeled vehicle in a traffic lane in which the two-wheeled vehicle is located and/or a position of at least one adjacent traffic lane that is adjacent to the traffic lane in which the two-wheeled vehicle is located; and
providing a blind spot warning responsive to object information that represents a position of another vehicle being inside the warning region.

17. A non-transitory computer-readable medium on which are stored instructions that are executable by a processor and that, when executed by the processor, cause the processor to perform a method for monitoring a blind spot of a two-wheeled vehicle, the method comprising:
defining at least one warning region at least partially comprising the blind spot using traffic lane information representing a position of the two-wheeled vehicle in a traffic lane in which the two-wheeled vehicle is located and/or a position of at least one adjacent traffic lane that is adjacent to the traffic lane in which the two-wheeled vehicle is located; and
providing a blind spot warning responsive to object information that represents a position of another vehicle being inside the warning region.
